(19) United States
(12) Patent Application Publication
(10) Pub. No.: US 2013/0323677 A1
(43) Pub. Date: Dec. 5, 2013

(54) Individualized endosseous dental implant

(71) Applicant: Thomas Stewart Pearson, Clovis, CA (US)

(72) Inventor: Thomas Stewart Pearson, Clovis, CA (US)

(21) Appl. No.: 13/507,058

(22) Filed: Jun. 1, 2012

(51) Int. Cl. A61C 8/00

(52) U.S. Cl. 433/173

(57) ABSTRACT

The instant invention is an individualized anatomic tooth root implant comprised of zirconia oxide or other biocompatible material, manufactured to very closely approximate an extracted tooth root and the existing extracted tooth root socket morphology. By so doing, invasive drilling and other dental procedures can be avoided. The implant consists of single or multiple root(s), the main implant body, a custom built abutment, and a dental prosthesis (crown), cemented to the abutment once sufficient healing and osseointegration has occurred. The the instant invention will have user defined additions and subtractions with circumferential grooves and ridges cut into the implant body below the coronal lip to insure better fit and retention.

### CROSS-REFERENCE TO RELATED APPLICATIONS

Not Applicable.

### STATEMENT REGARDING FEDERALLY SPONSORED RESEARCH or DEVELOPMENT

Not Applicable.

### REFERENCE to SEQUENCE LISTING

None.

### BACKGROUND OF THE INVENTION

The invention described herein is in the field of dental implants; the history of which has brought us innumerable designs and theories, composition and installation, but more precisely, this application will describe how to implant and follow natural human physiology and avoid unnecessary and invasive dental procedures that result in direct and indirect failures, unnecessary suffering and untold financial expenditures.

Typically, the dental implant process in today's market involves much pain, extensive healing periods, invasive medical procedures which increase legal liability, financial expense, and are causative factors for disadvantages and burdens borne by dentists, insurance companies, and patients alike. Therefore a paradigm shift in dental implanting is in order and the instant invention addresses these concerns.

This application for an individualized anatomic endosseous dental implant patent describes a radical and novel concept: Instead of designing a typically cylindrical-shaped implant to insert into a prepared osteotomy, why not design an implant that follows the natural extracted tooth shape and its resultant tooth root socket in the alveolar bone? Another way to simply state this is: Don't make the tooth socket fit the implant; make the implant fit the tooth socket.

Typically, dental implant preparation involves multiple steps of invasive drilling into the mandible/maxilla bone to insert a metal (generally titanium or titanium alloy), receptacle (socket), threaded on both the outside to facilitate placement and reception of the implant, which is rotated or screwed into a drilled and reamed bony osteotomy. A lengthy healing process requiring approximately three months to a year, allows for osseointegration of the socket to the mandible/maxilla bone. When the practitioner determines that sufficient healing has occurred, additional invasive procedures are performed to prepare for the placement of the implant which is primarily accomplished by rotational insertion of a threaded implant into the metal socket or self-tapping the implant into the mandible/maxilla bone. Depending on the implant chosen, there could be more invasive procedures such as cutting a flap, sutures and removal of same, and multiple pieces of abutments needing installation prior to the final crown placement.

There are important and distinct disadvantages to this process: lengthy healing time, numerous invasive procedures to the maxilla/mandible bones, risks of infection, incompatibility (allergies), of metal-to-human tissues along with risks of bodily rejection, extensive and numerous medical procedures, and higher costs associated with other types of implants.

The individualized anatomic tooth root implant as disclosed herein, is designed and manufactured to counter these disadvantages by instigating faster healing time (approximately three months or less); the implant is custom manufactured out of biocompatible material to approximate the natural, extracted tooth root structure, which avoids most invasive medical procedures, possibilities of rejection due to metal allergies, longer healing times, infections, higher liability and financial costs. Individualized anatomic endosseous dental implants are constructed of zirconium oxide which costs less to manufacture, and less to implant, thereby saving the consumer money. Additionally, the individualized anatomic tooth root implant does not contain threaded parts, so it is not screwed or rotationally inserted in a threaded fashion which is a torqued insertion requiring unnatural force application to the oral cavity structure, but is manufactured to be placed manually to fit the existing extracted tooth root socket. Applying torque to mandibular-placed implants is inherently dangerous due to the rotational aspect of the implant because the force is transferred along the threads which can easily result in mandibular fractures. Also, unlike other currently mass-produced implants available in the marketplace, the subject implant is individually custom-made and allows for user defined additions or subtractions with circumferential rings to more naturally fit the extracted tooth root socket with initial stabilization, it is press fit by hand with a more natural force to avoid damage to the surrounding bone (the implant is inserted in the extraction site), and finally, our unique design allows for excellent retention, faster osseointegration, and less opportunity for self-ejection, resulting in a more gratifying treatment for satisfied patients and dentists.

One important feature needing attention in dental implants is stress and shear forces from mastication which bear measurably on new dental implants and their design. U.S. Pat. No. 5,427,526, 1995, Fernandes, discloses “. . . cylindrical implants poorly distribute compressive forces and generate shear forces that may fragment and break the bone surrounding the implant during function.” Fernandes also discloses that “There are two main types of conventional implants, press fit & threaded. Both types are installed into a prepared recess made in the alveolar bone.” The exception is the instant invention which being closely made to the shape and size of the existing extracted tooth root socket, negates root socket preparation (invasive drilling into bone, inserting metal socket receptacles, or adding bone supplement to modify sockets to accept or fit unnaturally shaped implants). Fernandes further discloses, that “. . . one of the common causes of failure of traditional implants is excessive loading on a small section of alveolar bone due to the inadequate distribution of loading forces” He also states that . . . “screw implants exert six times the force of normal teeth on the alveolar bone . . . .”

Fernandes mentions a conically tapered implant in U.S. Pat. No. 3,979,828 (Taylor), “. . . more favorable force distribution would be obtained if the implant taper closely matches the recess in the alveolar bone after a single rooted tooth has been extracted.” A major benefit of the instant invention is exactly that, it approximates the extracted tooth root and tooth root socket of the alveolar bone. U.S. Pat. No. 5,766,010, (Uemura), discloses that in JA Pat. Pub. No. 7-36827, “. . . this implant body (cylindrical shaped), has a problem because stress is concentrated at corners of the implant body that the implant body itself has a tendency to break and parts of the bone (alveolar), likely to be damaged.”

Fernandes states that in U.S. Pat. No. 3,979,828, 1976, Taylor, “The press-fitted implant lacks a macro retention mechanism, making it vulnerable to movement.” With the individualized anatomic endosseous dental implant, the novel design allows for user defined additions and/or subtractions on the implant surface with circumferential rings cut into the lower parts of the implant, leaving a ridge between the grooves which aid immeasurably in retaining the implants without damaging the surrounding bones during insertion, and would avoid higher bone resorption as is seen in other implants. Also, Fernandes remarks that U.S. Pat. No. 3,849,887, 1974, (Brainin), where threaded implants were disclosed, “With threaded implants the bone that grows between the flutes of the thread on the implant can be sheared away and fragmented due to the high levels of shear stress generated at these points during function. This is a significant area of weakness for a threaded implant, since the implant has a tendency to loosen in the socket and therefore must be removed and replaced by a larger diameter implant.”

Another key feature addressed by Fernandes is seen in the Canadian Patent Application No. 2029646, laid open to Propper in 1991, whereby he discusses difficulties experienced in the process of obtaining implant forms from the extracted tooth root sockets using conventional means such as impression material which can seep or leak into the surrounding tissue (especially sensitive in sinus areas), where infection can occur and resulting facial-sinus surgery could result. Using modern x-ray technology and other image acquisition available to dentists today, accurate measurements can be obtained without the dangers noted above.

Another feature of our tooth root implant is surface preparation. While in its green state, the implant is blasted with zirconium oxides; the surface becomes pitted which will encourage bony ingrowth and better adhesion. The implant is then sintered, with the entire process leading to improved osseointegration.

### BRIEF SUMMARY OF THE INVENTION

An object of the present invention is to satisfy the growing dental implant field with a truly anatomic tooth root implant which can be immediately inserted after extraction and is uniquely designed to offer stabilization/retention in the alveolar bone of the mandible or maxilla without the use of invasive drilling and reaming to install a threaded-type, or screw-type implant that requires rotational insertion.

Another object of the present invention once osseointegration occurs, is to evenly distribute compressive forces and minimize shear forces during function. By manufacturing each implant individually to fit the existing tooth root structure, these forces are better distributed along the socket walls instead of focusing forces along the alveolar bone at the implant apex. This type of installation reduces the number of invasive medical procedures which leads to faster healing, less pain, and lower costs associated with dental implants.

The design of the present invention also allows osseointegration to occur without disruption by implanting an anatomic tooth root implant with a custom built abutment, which while approximating the extracted tooth root and tooth root socket dimensions, is out of occlusion, thus avoids mastication with its compressive and shear forces until osseointegration occurs approximately three months later. Once osseointegration takes place, the prosthesis (crown), can then be cemented to the custom built abutment thereby completing the implant process which will allow for more efficient distribution of compressive and shear forces associated with mastication.

### BRIEF DESCRIPTION OF THE DRAWINGS

In the accompanying drawings: (All drawings changes to show triangular edges on rings instead of square edges to comport with FDA 510(k) paperwork submission).

FIG. 1A shows the facial view of a premolar single root implant on the left, and FIG. 1B shows a two-rooted molar implant;

FIG. 2A shows the proximal view of the same premolar and FIG. 2B shows a molar implant as viewed in FIG. 1B;

FIG. 3A and FIG. 3B show the same proximal view as in FIG. 2, but with added numbers for the embodiments.

FIG. 3A shows the left premolar implant form, and FIG. 3B shows the molar form which is indicative of an extracted tooth root/tooth root socket which often is uniquely shaped with various sizes and forms, yet it conforms to the individual's extracted tooth/tooth root socket.

### DETAILED DESCRIPTION OF THE INVENTION

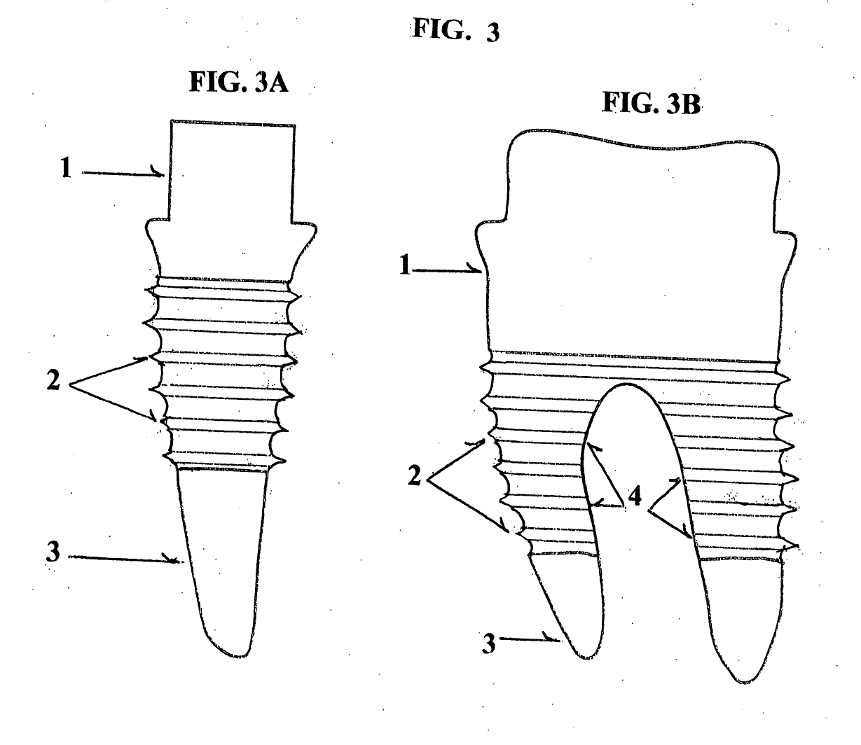

The premolar implant as viewed on the left side in FIG. 3 consists of a custom built abutment on the coronal end (1), to which a dental prosthesis is attached after sufficient healing has occurred (approximately three months); there are user-defined circumferential rings cut into the implant body and root area (2), which may or may not extend beyond the natural tooth side boundaries, additionally, the outer edges of these rings may be square, rounded, or triangular as indicated. The premolar apical end (3), is shaped to fit back into the existing extracted tooth root socket of the patient's mandible or maxilla, following the natural route of the extracted tooth.

The molar implant as viewed on the right side of FIG. 3B, consists of a custom built abutment on the coronal end (1), to which a dental prosthesis is attached after sufficient healing has occurred (approximately three months);
There are user-defined circumferential rings cut into the implant body and root area (2), which may or may not extend beyond the natural tooth side boundaries;
The molar apical end (roots), (3), are shaped to fit back into the existing extracted tooth root socket of the patient's mandible or maxilla, following the natural route of the extracted tooth;
The molar furcation (4), is uniquely shaped so that no circumferential rings are cut along these inner-facing surfaces as they are deemed unnecessary for the proper fit of the implant.

This invention is an individualized anatomic endosseous dental implant that represents a unique departure from existing dental implants because it is based on the existing tooth root structure of an extracted tooth in either the mandible/maxilla bones. Current dental implant practice is to mass produce a uniform cylindrically-shaped implant, either using titanium/titanium alloy, or more recently zirconium oxide as in the instant device. Other implants employ various macro retentive forms, but the vast majority of implant makers rely on threaded devices placed, cut, or machined along the implant body from just below the coronal lip to the apical bottom, others are placed in portions of the implants; some titanium alloy implants are made to be self-tapping, while almost all require invasive bone drilling prior to implant placement. The instant implant being made in the shape of the extracted tooth root socket (alveolus), requires no drilling, reaming, or other invasive procedure but is hand fit and gently tapped with a mallet and driver for proper seating.

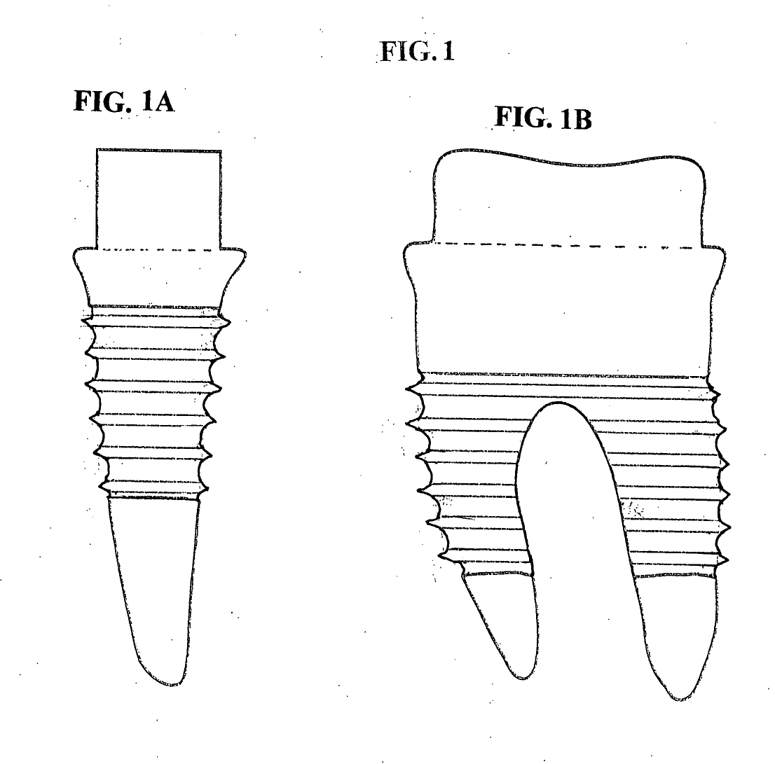

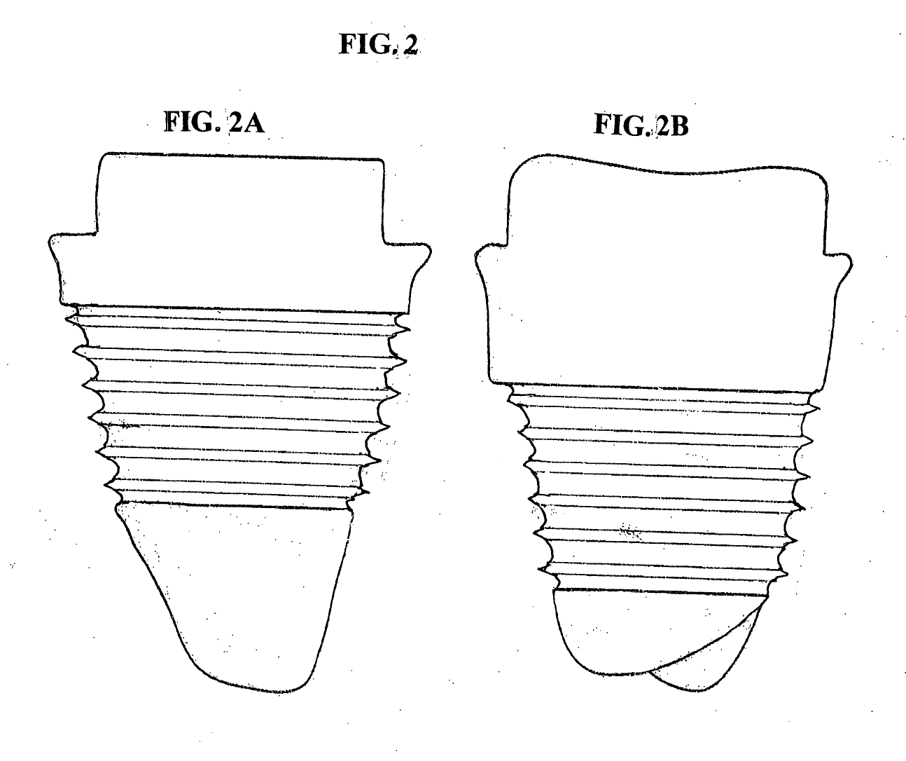

The instant device begins as a solid zirconium oxide blank, it is then placed into a milling device and using data extracted from x-rays or other imaging device images of an extracted tooth and/or tooth root socket, the data is fed into the milling machine along with user defined additions and/or subtractions as macro retentions called circumferential rings, are cut and placed along the implant surface (See FIGS. 1, 2, and 3), which then creates the replica of the extracted tooth with a custom built abutment on the coronal surface (See FIG. 1. Prior to sintering (commonly known as the green state), the implant is subject to blasting with zirconium oxides which result in a pitted surface below the coronal area (See FIGS. 1 and 2), which induce osseointegration of the implant to alveolar bone.

1. An individualized, one-piece anatomic tooth root implant made of zirconium oxide, titanium, or other biocompatible material and is made to approximate the extracted tooth root morphology. The instant device is intended to replace a recently extracted tooth without invasive drilling or bone augmentation/bonegrafting procedures.

2. An individualized, one-piece anatomic tooth root implant as described in claim 1, wherein although consisting of a one-piece body, the implant contains a custom built abutment on top, to which a dental prosthesis is cemented. Additionally, the implant is manually placed in the extracted tooth's socket of the patient's mandible or maxilla, then further tapped into place for retention with a driver and mallet, which will reduce pain, cost, and healing time.

3. An individualized, one-piece anatomic tooth root implant as described in claim 1, wherein the implant has four distinctive parts: the root(s), single or multiple, located on the implant's lower part; the implant body, located just above the roots on the implant's middle part; the custom built abutment located on the implant's upper part; and the dental prosthesis cemented to the abutment, located on the implant's top part.

4. An individualized, one-piece anatomic tooth root implant as described in claim 3, wherein although the implant itself will approximate the extracted tooth root socket, the lower and middle portions of the implant will have user-defined additions and/or subtractions visualized as circumferential rings depending on the natural shape of the extracted tooth root, to insure a more accurate fit.

5. An individualized, one-piece anatomic tooth root implant as described in claim 4, wherein the lower and middle implant parts will have circumferential grooves cut across the implant to increase retentive strength and encourage optimum osseointegration.

6. An individualized, one-piece anatomic tooth root implant as described in claim 5, wherein the grooves that cut across the lower and middle implant parts will have ridges as a result of the grooving process which will leave outer edges that are flat, round, or triangular.

7. An individualized, one-piece anatomic tooth root implant as described in claim 1, wherein the implant will be inserted into the extracted tooth root socket manually and tapped into place using a mallet and driver; the user defined additions and/or subtractions are the circumferential rings which will make sufficient contact with the palatinial and lingual bones to insure the best fit and although some bone resorption will occur, this is actually beneficial to bone growth or commonly referred to as osseointegration.
